(19) United States
(12) Patent Application Publication
(10) Pub. No.: US 2010/0090789 A1
(43) Pub. Date: Apr. 15, 2010

(54) Method, system and transformer for mitigating harmonics

(75) Inventors: Robert Schluter, Kinnelon, NJ (US); James A. Herrick, JR., Wanaque, NJ (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Middle Atlantic Products, Inc.

(21) Appl. No.: 12/455,779

(22) Filed: Jun. 5, 2009

Related U.S. Application Data
(60) Provisional application No. 61/196,168, filed on Oct. 14, 2008.

(51) Int. Cl. H01F 27/29

(52) U.S. Cl. 336/192

(57) ABSTRACT

In one aspect a single-phase transformer is provided that includes: a primary side configured to receive a primary line to line voltage of a three-phase source; and a secondary side configured to output a secondary line to line voltage having a zero amplitude and substantially similar first and second line to neutral secondary voltages. In other aspects of the invention, systems and methods are provided for mitigating harmonics that employ the transformer.

### RELATED APPLICATION

This application is related to and claims priority from U.S. Provisional Application No. 61/196,168, filed on Oct. 14, 2008, which is incorporated herein by reference in its entirety.

### FIELD OF THE INVENTION

This invention pertains generally to electrical apparatuses and systems. More particularly, the present invention pertains to power distribution methods, systems and transformers for mitigating harmonics.

### BACKGROUND OF THE INVENTION

Harmonic distortion is an increasing problem due to the increase of electronic loads. Harmonics by definition are a steady state distortion of the fundamental frequency −60 Hz. Harmonic distortion occurs when sinusoidal voltage is applied to a non-linear load (e.g., electronic ballast, PLC, adjustable-speed drive, ac/dc converter and other power electronics). The result is a distortion of the fundamental current waveform. The more devices that are present, the greater the likelihood of this type of voltage distortion and the greater the likelihood of adverse effects on other equipment.

The odd multiples of the third harmonic (e.g., 3rd, 9th, 15th, 21st etc.) are known in the art as “triplen” harmonics. Triplen harmonics are of particular concern because they are zero sequence harmonics and, therefore, are additive. This additive property can lead to very large currents in the neutral of a three-phase system, or which circulate in the primary of a delta-configured transformer. Unless the neutral or primary transformer winding is sufficiently oversized, triplen harmonics can cause overheating, equipment failure or a fire hazard. Various solutions to the triplen problem have been proposed including harmonic filtering transformers, zig-zag transformers, and K-rated transformer. Although approaches using these solutions have enjoyed some level of success, nevertheless, new transformers, systems and methods for mitigating triplen harmonics would be an important improvement in the art.

### BRIEF SUMMARY OF THE INVENTION

In one aspect of the invention a single-phase transformer is provided that includes: a primary side configured to receive a primary line to line voltage of a three-phase source; and a secondary side configured to output a secondary line to line voltage having a zero amplitude and substantially similar first and second line to neutral secondary voltages. The secondary side of the transformer includes: a first winding including first and second ends; a second winding including third and fourth ends; and a connector electrically connecting the second end and the fourth end, wherein a first line to neutral secondary voltage is defined between the first end and the fourth end, and wherein a second line to neutral secondary voltage is defined between the third end and the second end. In other aspects of the invention, systems and methods are provided for mitigating harmonics that employ the transformer.

### BRIEF DESCRIPTION OF THE DRAWINGS

For the purpose of illustrating the invention there is shown in the drawings various forms which are presently preferred; it being understood, however, that this invention is not limited to the precise arrangements and instrumentalities particularly shown.

FIG. 1 is a schematic of a single-phase transformer according to an aspect of the present invention;

FIG. 2 is a schematic of an embodiment of a power distribution system for mitigating harmonics;

FIG. 3 is a schematic of another embodiment of a power distribution system for mitigating harmonics;

FIG. 4 illustrates an example front perspective view of the system of FIG. 3; and

FIG. 5 illustrates an example rear elevation view of the system of FIG. 4.

### DETAILED DESCRIPTION

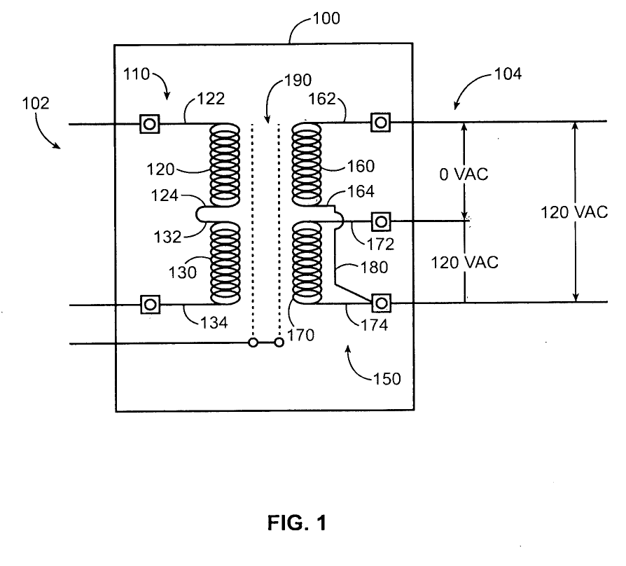

Turning now to the Figures, various example methods, systems and transformers for mitigating harmonics in accordance with the present invention will be described. An example embodiment of a transformer according to an aspect of the present invention is illustrated schematically in FIG. 1. As shown, the transformer 100 includes a primary side 102 that is configured to receive a primary voltage output by a voltage source (e.g., a feeder, distribution transformer secondary, etc.), and a secondary side 104 that is configured to output power to at least one load. The transformer 100 may be a conventional single-phase, dry-type, step-down transformer known in the art such as transformers available from Acme Electric of Lumberton, N.C. As is further shown, the primary side 102 includes a dual-winding primary 110 and a dual-winding secondary 150. The dual-winding primary and secondary 110, 150 may be configured on separate legs of a conventional transformer core known in the art. The dual-winding primary 110 includes a first primary winding 120 with a first end 122 and a second end 124, and a second primary winding 130 with a first end 132 and a second end 134. Although transformers according to the present invention may be configured to receive various primary voltages (e.g., by using various winding taps, which are not shown), the present example transformer 100 will be described as receiving a 480 volt, line to line voltage that is typically provided to commercial and/or industrial customers by utilities. Accordingly, to receive a 480 volt, line to line voltage, the second end 124 of the first winding 120 is electrically connected (e.g., using a coupling member such as a wire, cable, jumper, bus bar, clamp, solder, etc.) with a first end 132 of the second primary winding 130 so that the primary voltage is connected between the first end 122 of the first primary winding 120 and the second end 134 of the second primary winding 130.

As shown, a dual Faraday shield 190 may be interposed between the dual-winding primary 110 and the dual-winding secondary 150 to reduce the electromagnetic interference or noise that may be capacitively coupled between the windings of the transformer 100. The dual-winding secondary 150 includes a first secondary winding 160 with a first end 162 and a second end 164, and a second secondary winding 170 with a first end 172 and a second end 174. Conventionally, the first and second secondary windings 160, 170 would be electrically interconnected to provide at least one of a 240 volt line to line output, a 240 volt line to line/120 volt line to neutral (i.e., split phase/center-tapped voltage) output, and a 120 volt line to line output. For example, a common residential-type 120/240 volt output may be provided by interconnecting the second end 164 of the first secondary winding 160 with the first end 172 of the second secondary winding 170 such that the 240 volt output appears between the first end 162 of the first secondary winding 160 and the second end 174 of the second secondary winding 170, whereas the 120 volt outputs appear between: 1) the first end 162 of the first secondary winding 160 and the second end 164 of the first secondary winding 160; and 2) the second end 174 of the second secondary winding 170 and the first end 172 of the second secondary winding 170. In another example, a 120 volt output may be provided by configuring the first and second secondary windings 160, 170 in parallel (i.e., by interconnecting first ends 162, 172 together and interconnecting second ends 164, 174 together). Nevertheless, although the transformer 100 may be of the conventional type, the windings of the dual-winding secondary 150 are electrically interconnected in a unique way to provide a zero-amplitude (i.e., 0 volt) line to line voltage and two 120 volt line to neutral voltages. To this end, the second end 164 of the first secondary winding 160 is electrically connected (e.g., using a coupling member 180 such as a wire, cable, jumper, bus bar, clamp, solder, etc.) with a second end 174 of the second secondary winding 170 so that: 1) 0 volts appears between the first end 162 of the first secondary winding 160 and the first end 172 of the second secondary winding 170; and 2) two 120 voltages appear that are one hundred eighty degrees out of phase—a first 120 voltage being between the first end 162 of the first secondary winding 160 and the second end 174 of the second secondary winding 170, and a second 120 voltage being between the first end 172 of the second secondary winding 170 and the second end 174 of the second secondary winding 170.

In contrast to a conventional 120/240 secondary output where the neutral current arises from having unbalanced loads on each line to neutral segment of the secondary side 104, in the illustrated configuration of FIG. 1 the line to neutral voltages are in phase and the neutral current is equal to the sum of the line loads. That is, if each line to neutral segment of the secondary side 104 is carrying 100 amps, the neutral current would be 200 amps. It can be appreciated that this configuration of the first and second secondary windings 160, 170 is useful in mitigating harmonics because it establishes a new ground reference at the point of use. That is, the neutral point (i.e., end 164 and/or end 174) of the secondary side 104 is effectively grounded (i.e., zero potential) as defined by the line to neutral voltages.

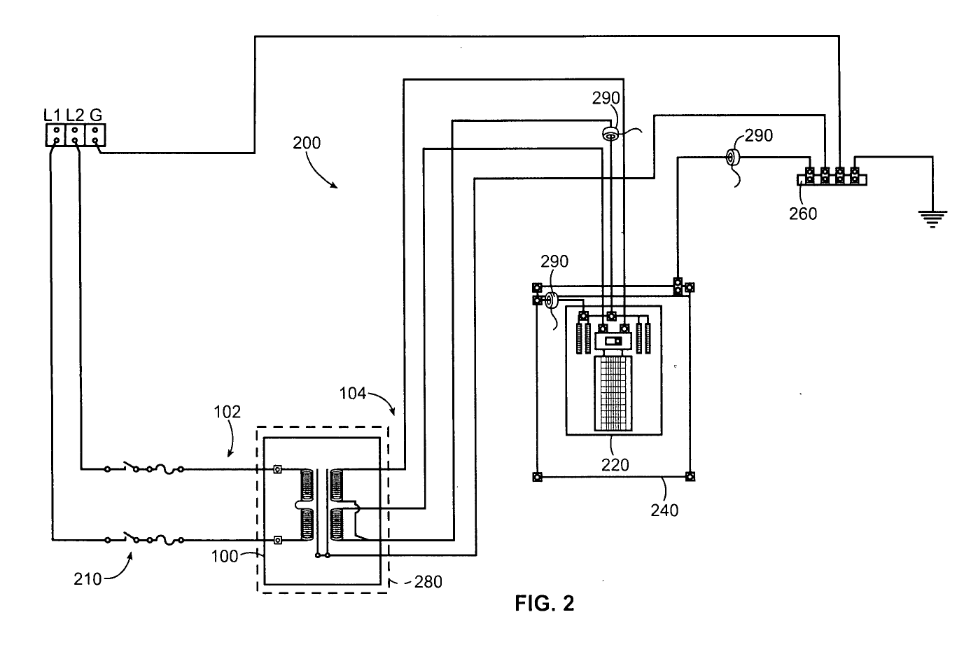

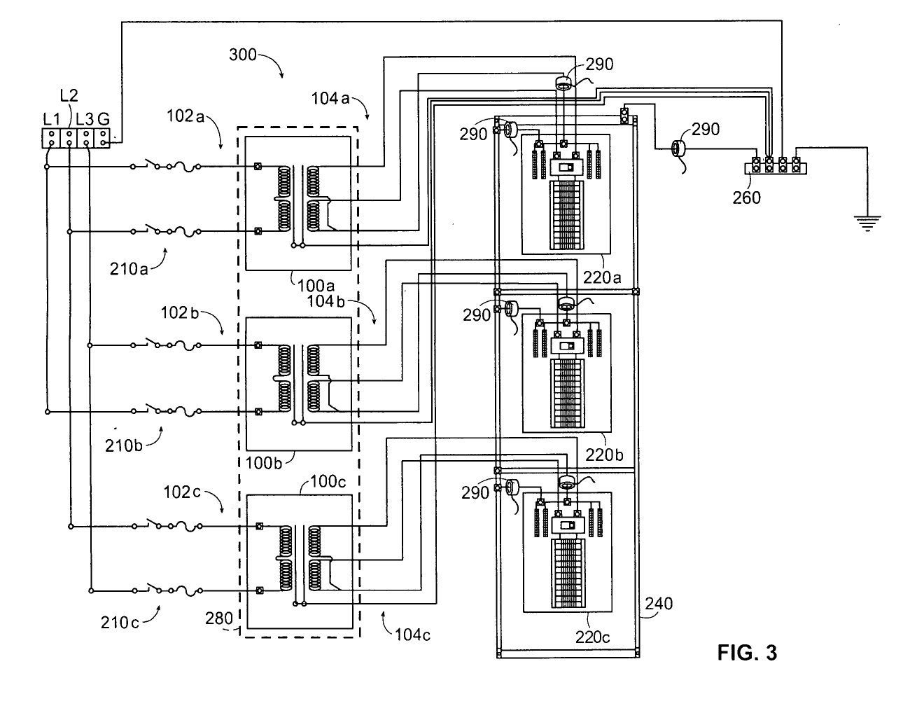

Turning now to FIG. 2, a first embodiment of a system for mitigating harmonics will be described. The first embodiment of the system 200 is particularly useful for mitigating harmonics in the context of nonlinear loads/equipment used in the audio, video and broadcast applications. However, it should be appreciated that systems in accordance with the present invention are not limited to audio, video and broadcast contexts or applications. As shown schematically, the system 200 includes a circuit breaker panel or load center (collectively referred to hereinafter as a load center) 220 and the previously-described, single-phase transformer 100 of FIG. 1. The system 200, particularly the primary side 102 of the transformer 100, receives power from a source, which as shown is a single-phase, three-wire, line to line voltage source (L1, L2, G). A main disconnect 210, for example a fused switch, may be interposed between the voltage source and the primary side 102 for shutting off power to the system 200. The illustrated system 200 includes one transformer 100. However, it should be appreciated that the system 200 may include additional transformers 100 relative to the load connected to the system 200. In instances when the system 200 includes more than one transformer 100 (e.g., two, three or more transformers), each transformer 100 may be electrically connected to the same source. Because the system 200 employs separate single-phase transformers 100 instead of a multi-phase (e.g., three-phase) transformer having different phase windings on a common core, harmonics (e.g., triplen—odd integer multiples of the third harmonic) are not added. For example, as will be described hereinafter with regard to FIG. 3, when the source is three-phase, three transformers 100 may be provided with each transformer being connected between different phases. Because one common source of magnetic interference is the power electronics that is used in audio, video and broadcast equipment, the transformer 100 may be enclosed by a magnetic shield 280 (e.g., a triple magnetic shield) as shown in FIG. 2 for preventing external magnetic fields from generating unwanted signals in the transformer 100.

The load center 220 may be a conventional load center or circuit breaker panel known in the art with a main (i.e., dual pole) circuit breaker, at least one load (i.e., single pole) circuit breaker for supplying power to at least one load, hot and neutral bus bars, etc. The load center 220 may be configured to have a 200 amp rating, and a 100 amp, two pole main circuit breaker. The load center 220 is electrically connected with the secondary side 104 of the transformer 100 for receiving a stepped-down voltage output from the secondary side 104 and for providing power to at least one load (not shown). The neutral point (i.e., end 164 and/or end 174 shown in FIG. 1) of the secondary side 104 is electrically connected with a neutral connection or neutral bus bar of the load center 220, whereas one side (e.g., the right side as shown in FIG. 2) of the main circuit breaker is electrically connected with the end 162 (FIG. 1) and the other side (e.g., the left side as shown in FIG. 2) of the main circuit breaker is electrically connected with the end 172 (FIG. 1).

As further shown, the system 200 includes a ground system including a ground ring 240 surrounding the load center 220, and a main ground bus/bar 260. The ground ring 240 is electrically connected with the neutral bus of the load center 220, and the ground ring 240 is electrically connected with the main ground bus/bar 260 that is connected to ground/earth (e.g., the grounding electrode system of the building housing the system 200). Furthermore, the Faraday shield 190 of the transformer 100 is electrically connected with the main ground bus/bar 260. The ground system may further include a diagnostic apparatus for monitoring ground currents flowing in or through various components of the ground system.

As shown, the diagnostic apparatus may include one or more current sensors 290 for detecting/monitoring current. The system 200 includes three current sensors 290 as shown in FIG. 2, however, fewer or additional current sensors 290 may be provided. As shown, the system 200 includes a first current sensor 290 for detecting/monitoring ground current flowing between the transformer 100 and the load center 220 (particularly the neutral of load center 220), a second current sensor 290 for detecting/monitoring ground current flowing between the load center 220 and the ground ring 240, and a third current sensor 290 for detecting/monitoring ground current flowing between the ground ring 240 and the main ground bus/bar 260. The current sensors 290 may output signals relative to detected/monitored currents to, for example, a computer or the like for storing and analyzing the currents and/or loads.

Turning now to FIG. 3, another embodiment of the system for mitigating harmonics will be described. As shown schematically, the system 300 includes three load centers 220a-c and three single-phase transformers 100a-c (i.e., the previously-described transformer 100 of FIG. 1). The three load centers 220a-c and three single-phase transformers 100a-c are interconnected with each other in a one-to-one relationship to define transformer/load center pairs. That is, as shown transformer 100a is electrically connected with load center 220a, transformer 100b is electrically connected with load center 220b, and transformer 100c is electrically connected with load center 220c. However, the three load centers 220a-c and three single-phase transformers 100a-c may be electrically interconnected in various ways (e.g., transformer 10a electrically connected with load center 220b or 220c, etc.)

The system 300, particularly the primary sides 102a-c of the transformers 100a-c, receive power from a source, which as shown is a three-phase, four-wire, line to line voltage source (L1, L2, L3, G). However, the system 300 may include fewer transformers (e.g., two transformers) relative to the source. Main disconnects 210a-c, for example fused switches, may be interposed between the voltage source and the primary sides 102a-c of transformer 100a-c for shutting off power to the system 300. Although three main disconnects 210a-c are shown for separately and/or selectively disconnecting each transformer 100a-c from its respective phase, fewer disconnects may be provided. For example, the system 300 may include one main disconnect for simultaneously shutting off power to all of the transformers 100a-c.

As shown, primary 102a of first transformer 100a is electrically connected with a first phase (L1, L2) of the source. Similarly, primary 102b of second transformer 100b is electrically connected with a second phase (L3, L1) of the source, and primary 102c of third transformer 100c is electrically connected with a third phase (L2, L3) of the source. However, as should be appreciated, the transformers 100a-c may be interconnected with different phases (e.g., transformer 100a being electrically connected with phase (L2, L3) or phase (L3, L1), etc.). As mentioned previously, the transformers 100a-c may be enclosed by a magnetic shield 280 (e.g., a triple magnetic shield) for preventing external magnetic fields from generating unwanted signals in the transformers 100a-c. Although one magnetic shield 280 is shown enclosing all three transformers 100a-c, each transformer may be enclosed in its own magnetic shield 280. As noted previously in conjunction with the description of system 200, because system 300 employs separate single-phase transformers 100a-c instead of a multi-phase (e.g., three-phase) transformer having different phase windings on a common core, harmonics (e.g., triplen—odd integer multiples of the third harmonic) are not added.

The load centers 220a-c may be conventional load centers or circuit breaker panels known in the art, each with a main (i.e., dual pole) circuit breaker, at least one load (i.e., single pole) circuit breaker for supplying power to at least one load, hot and neutral bus bars, etc. The load centers 220a-c may be configured to have a 200 amp rating, and a 100 amp, two pole main circuit breaker. The load centers 220a-c are electrically connected with the secondary sides 104a-c of the transformers 100a-c for receiving a stepped-down voltage output from the secondary sides 104a-c and for providing power to at least one load (not shown). The neutral point (i.e., end 164 and/or end 174 shown in FIG. 1) of each secondary side 104a-c is electrically connected with a neutral connection or neutral bus bar of a respective load center 220a-c. Furthermore, one side of the main circuit breaker of each load center 220a-c is electrically connected with the end 162 (FIG. 1), and the other side of the main circuit breaker of each load center 220a-c is electrically connected with the end 172 (FIG. 1).

As further shown, the system 300 includes a ground system including a ground ring 240 surrounding the load centers 220a-c, and a main ground bus/bar 260. The ground ring 240 is electrically connected with the neutral bus of each load center 220a, -c, and the ground ring 240 is also electrically connected with the main ground bus/bar 260 that is connected to ground/earth (e.g., the grounding electrode system of the building housing the system 300). Furthermore, the Faraday shield 190 of each of the transformers 100a-c is electrically connected with the main ground bus/bar 260.

The ground system may further include a diagnostic apparatus for monitoring ground currents flowing in or through various components of the ground system. As shown, the diagnostic apparatus may include one or more current sensors 290 for detecting/monitoring current. The system 300 includes seven current sensors 290 as shown in FIG. 3, however, fewer or additional current sensors 290 may be provided. As shown, the system 300 includes three current sensors 290 for detecting/monitoring ground current flowing between the transformers 100a-c and the respective load centers 220a-c (particularly the neutral of load centers 220a-c), three current sensors 290 for detecting/monitoring ground current flowing between the load centers 220a-c and the ground ring 240, and a current sensor 290 for detecting/monitoring ground current flowing between the ground ring 240 and the main ground bus/bar 260. As mentioned previously, the current sensors 290 may output signals relative to detected/monitored currents to, for example, a computer or the like for storing and analyzing the currents and/or loads.

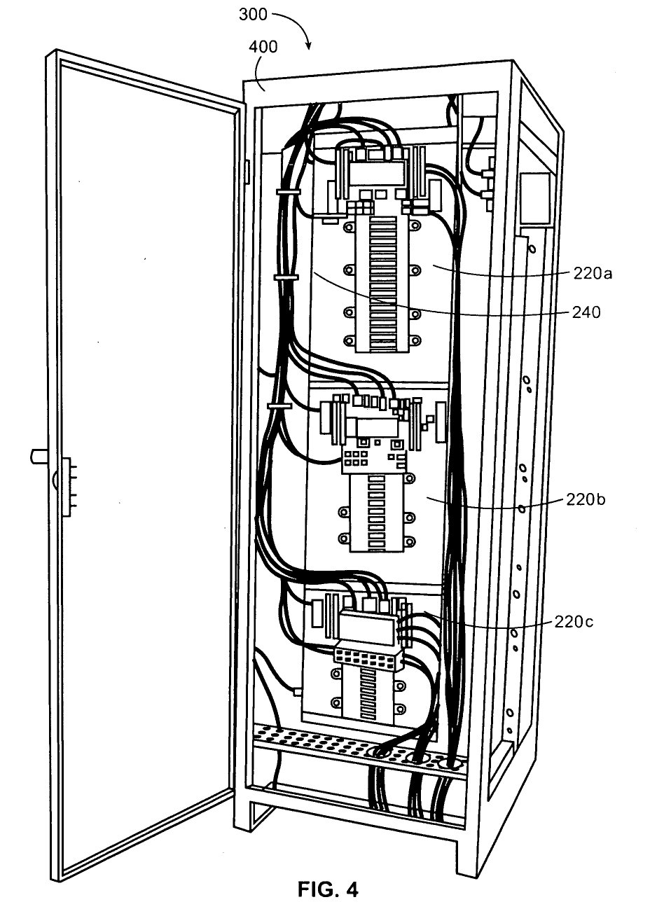

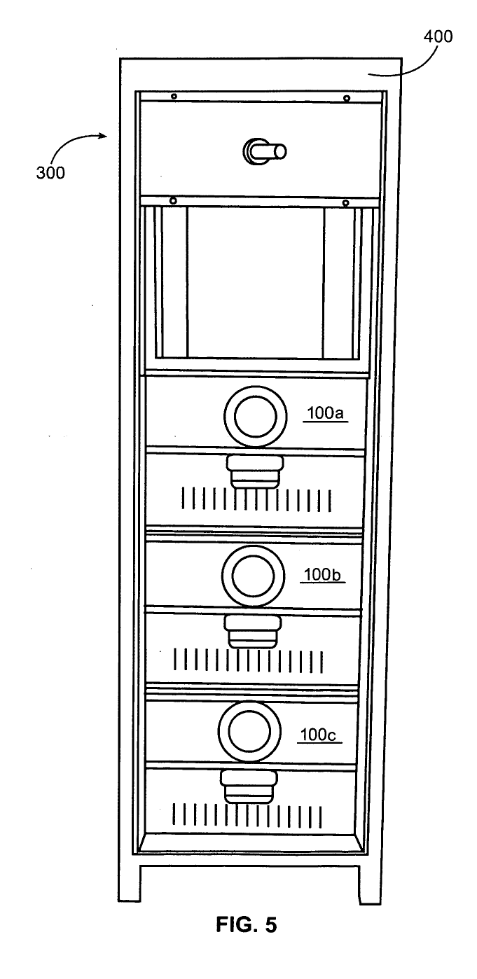

Turning now to FIGS. 4 and 5 the system 300 is further described. As shown in FIG. 4, the components of system 300 may be housed in a common enclosure 400. Although not shown, it should be appreciated that the components of system 200 may also be configured in a common enclosure. The enclosure 400 may be a rack (e.g., nineteen inch or twenty-three inch standard-sized racks known in the art which are commonly used for audio, video, broadcast or telecommunications equipment) or a cabinet with one or more doors (e.g., front and or rear doors). As shown in FIG. 4, the load centers 220a-c are configured in a vertical orientation with one or more ground rings 240 surrounding each of the load centers 220a-c. As shown in FIG. 5, the transformers 100a-c are also configured in a vertical orientation corresponding to the load centers 220a-c.

Using the present transformer and system, a method of mitigating harmonics is provided. An example method includes the steps of: interconnecting first and second secondary windings of a single-phase transformer to output substantially similar first and second line to neutral secondary voltages and a zero-amplitude line to line voltage; and electrically connecting the first and second secondary windings to a load center feeding at least one nonlinear load for establishing a new ground reference and for supplying the substantially similar first and second line to neutral secondary voltages to the at least one nonlinear load.

By employing transformers and systems described herein according to the present invention a number of benefits may be realized including: 1) triplen harmonics are not present; 2) a common ground grid (ground plane) is provided; 3) neutral and ground bonds may be located in close proximity to each other and on the common ground grid; 4) common building safety and grounding electrode connection is provided; 5) a new ground reference is established at the point of use; and 6) reduced common mode currents.

The use of the terms “a” and “an” and “the” and similar referents in the context of describing the invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Various embodiments of this invention are described herein. However, it should be understood that the illustrated embodiments are exemplary only, and should not be taken as limiting the scope of the invention.

What is claimed is:

1. A single-phase transformer comprising:
a primary side configured to receive a primary line to line voltage of a three-phase source; and
a secondary side configured to output a secondary line to line voltage having a zero amplitude and substantially similar first and second line to neutral secondary voltages.

2. The transformer of claim 1 wherein the secondary side comprises:
a first winding including first and second ends;
a second winding including third and fourth ends; and
a connector electrically connecting the second end and the fourth end,
wherein a first line to neutral secondary voltage is defined between the first end and the fourth end, and
wherein a second line to neutral secondary voltage is defined between the third end and the second end.

3. The transformer of claim 2 wherein the primary side comprises:
a third winding including fifth and sixth ends;
a fourth winding including seventh and eighth ends; and
a second connector electrically connecting the sixth end and the seventh end, the primary line to line voltage being connected between the fifth end and the eighth end.

4. The transformer of claim 1 further comprising a double Faraday shield interposed between the primary and secondary sides.

5. The transformer of claim 1 further comprising a magnetic shield enclosing the primary and secondary sides.

6. A transformer system comprising:
a single-phase transformer including a primary side configured to receive a primary line to line voltage of a three-phase source, and a secondary side configured to output substantially similar first and second line to neutral secondary voltages and a zero-amplitude line to line voltage; and
a load center electrically connected with the secondary side for providing the first and second line to neutral secondary voltages to at least one load.

7. The system of claim 6 wherein the secondary side comprises:
a first winding including first and second ends;
a second winding including third and fourth ends; and
a connector electrically connecting the second end and the fourth end,
wherein a first line to neutral secondary voltage is defined between the first end and the fourth end, and
wherein a second line to neutral secondary voltage is defined between the third end and the second end.

8. The system of claim 6 wherein the load center comprises at least one circuit breaker interposed between the secondary side and the at least one load.

9. The system of claim 6 further comprising a main disconnect interposed between the primary side and a voltage source outputting the primary line to line voltage.

10. The system of claim 6 further comprising a ground ring surrounding the load center.

11. The system of claim 10 further comprising:
a connector electrically connecting a neutral of the load center with the ground ring; and
a current sensor coupled with the connector for detecting a current flowing through the connector.

12. The system of claim 11 further comprising:
a main ground bus;
a second connector electrically connecting the main ground bus with the ground ring; and
a second current sensor coupled with the second connector for detecting a current flowing through the second connector.

13. The system of claim 7 wherein the primary side comprises:
a third winding including fifth and sixth ends;
a fourth winding including seventh and eighth ends; and
a second connector electrically connecting the sixth end and the seventh end, the primary line to line voltage being connected between the fifth end and the eighth end.

14. The system of claim 6 wherein the transformer further comprises a double Faraday shield interposed between the primary and secondary sides.

15. The system of claim 6 wherein the transformer further comprises a magnetic shield enclosing the primary and secondary sides.

16. The system of claim 6 further comprising an enclosure housing the single-phase transformer and the load center.

17. The system of claim 6 further comprising:
second and third single-phase transformers substantially similar to the first single-phase transformer, the second and third single-phase transformers including primary sides configured to receive respective second and third primary line to line voltage of the three-phase source, each of the second and third single-phase transformers outputting substantially similar first and second line to neutral secondary voltages and a zero-amplitude line to line voltage; and
second and third load centers electrically connected with secondary sides of the respective second and third single-phase transformers for distributing power to at least one load.

18. A method for mitigating harmonics in an electrical distribution system comprising:
interconnecting first and second secondary windings of a single-phase transformer to output substantially similar first and second line to neutral secondary voltages and a zero-amplitude line to line voltage; and
electrically connecting the first and second secondary windings with a load center feeding at least one nonlinear load for establishing a new ground reference and for supplying the substantially similar first and second line to neutral secondary voltages to the at least one nonlinear load.

19. The method of claim 18 further comprising using a current sensor to monitor neutral current between the single-phase transformer and the load center.

20. The method of claim 18 wherein the interconnecting step comprises:
electrically connecting a first end of the first winding with a first bus bar of the load center;
electrically connecting a first end of the second winding with a second bus bar of the load center;
connecting a first conductive member between a second end of the first winding and a second end of the second winding; and
electrically connecting a neutral bus of the load center with at least one of the second end of the second winding and the second end of the first winding.

21. The method of claim 20 further comprising:
surrounding the load center with a ground ring;
coupling a second conductive member between the ground ring and the neutral bus of the load center; and
using a current sensor to monitor ground current through the second conductive member.

22. The method of claim 21 further comprising:
coupling a third conductive member between the ground ring and a main ground bus; and
using a second current sensor to monitor ground current through the third conductive member.

23. The method of claim 21 further comprising:
interconnecting second and third single-phase transformers substantially similar to the first single-phase transformer in the same manner as the first single-phase transformer; and
electrically connecting the second and third single-phase transformers with respective second and third load centers in the same manner as the first load center is electrically connected to the first load center, each load center capable of feeding at least one nonlinear load.
